(19) United States
(12) Patent Application Publication
(10) Pub. No.: US 2005/0101370 A1
(43) Pub. Date: May 12, 2005

(54) Game play sequence for bingo gaming systems

(75) Inventors: Clifton Lind, Austin, TX (US); Brendan O'Connor, Austin, TX (US); Jefferson C. Lind, Austin, TX (US)

Correspondence Address: THE CULBERTSON GROUP, P.C., 1114 LOST CREEK BLVD., SUITE 420, AUSTIN, TX, 78746, US

(73) Assignee: Multimedia Games, Inc.

(21) Appl. No.: 10/981,244

(22) Filed: Nov. 4, 2004

Related U.S. Application Data
(60) Provisional application No. 60/517,707, filed on Nov. 6, 2003.

(51) Int. Cl. A63F 13/00

(52) U.S. Cl. 463/19

(57) ABSTRACT

Apparatus and methods are described for a game play sequence for an electronic bingo gaming system. The electronic bingo gaming system includes a number of player stations that players may use to participate in a bingo game and a game server for implementing/carrying out the game play sequence. The sequence begins by splitting a ball draw for a bingo game into a first portion and a final portion. A series of potential game ending winning players may be identified. The first potential game ending winning player in the series who makes the appropriate inputs in response to their receiving the first portion of the ball draw and the final portion of the ball draw, receives a prize in the bingo game.

### CROSS-REFERENCE TO RELATED APPLICATION

The Applicants claim the benefit, under 35 U.S.C. § 119(e), of U.S. Provisional Patent Application No. 60/517,707, filed Nov. 6, 2003 and entitled “Game Play Sequence For Bingo Gaming Systems.” The entire content of this provisional application is incorporated herein by this reference.

### TECHNICAL FIELD OF THE INVENTION

This invention relates to electronic bingo gaming systems. In particular, the invention is directed to apparatus and methods for using player inputs in the course of a bingo game to help determine a winning player in the bingo game and award that player an appropriate prize.

### BACKGROUND OF THE INVENTION

Electronic bingo gaming systems have been increasing in popularity as players have turned to a faster paced alternative than traditional bingo games. Electronic bingo gaming systems allow players at different gaming facilities, which may be spaced apart over a large geographic area, to participate in bingo games through electronic player stations that are maintained at the various gaming facilities. An electronic bingo gaming system generally includes a game processing device that compares a ball draw or other sequence of randomly generated numbers to a set of data representations of bingo cards for a given bingo game and identifies winning patterns that are achieved for the various card representations. The results identified by the bingo game processing device may then be communicated back to the various player stations to be displayed to the various players in the bingo game. This process of identifying winning patterns and returning results to the player stations may be performed very quickly with modern computing devices and network communications arrangements. The speed with which results may be returned to the players and other aspects of the systems also give electronic bingo gaming systems a great deal of flexibility in presenting the results to the players. It may be difficult, however, to provide the speed of play and the result presentation flexibility of electronic bingo gaming systems, while retaining the aspects of player interaction found in traditional bingo games.

### SUMMARY OF THE INVENTION

The present invention includes apparatus and methods for ensuring a particular game play sequence in an electronic bingo gaming system. A method according to the invention includes splitting a ball draw for a bingo game into a first portion and a final portion to ensure that a first potential game ending winning player is not identified after considering only the first portion. A first portion of the ball draw is then presented to a first potential game ending winning player. The final portion of the ball draw is then presented to the first potential game ending winning player in the event that the first potential game ending winning player enters a daub input according to a daub input rule. A prize is then awarded to the first potential game ending winning player in the event that the first potential game ending winning player enters a prize claiming input according to a prize claiming input rule.

Another method within the scope of the present invention includes splitting a ball draw for a bingo game into a first portion and a final portion and identifying a series of one or more potential game ending winning players. This method further includes presenting the first portion of the ball draw, the final portion of the ball draw, and a prize to the first of the one or more potential game ending winning players to enter two or more separate player inputs according to player input rules of the bingo game.

An apparatus according to the present invention includes a number of player stations through which a respective player may participate in a bingo game. Each player station includes a display and one or more player input devices. The apparatus also includes a game server for splitting a ball draw for the bingo game into a first portion and a final portion. The game server also functions to identify a series of one or more potential game ending winning players and to direct a respective player station to present the first portion of the ball draw, the final portion of the ball draw, and a prize indicator. The respective player station comprises the player station for the first of the one or more potential game ending winning players to enter two or more player inputs according to input rules for the bingo game.

These and other advantages and features of the invention will be apparent from the following description of preferred embodiments, considered along with the accompanying drawings.

### BRIEF DESCRIPTION OF THE DRAWINGS

FIG. 1 is a high level diagrammatic representation of a bingo gaming system embodying the principles of the present invention.

FIG. 2 is a diagrammatic representation of a computer system arrangement that may be used for the central game server and local area servers included in the system shown in FIG. 1.

FIG. 3 is a diagrammatic representation of an electronic player station that may be used in the system shown in FIG. 1.

FIG. 4A is a flow chart showing a sequence of play embodying the principles of the present invention for game ending winning players.

FIG. 4B is a flow chart continued from FIG. 4A showing a remainder of a sequence of play for non-game ending winning players.

### DESCRIPTION OF PREFERRED EMBODIMENTS

The present invention may be used for the sequence of play in many different types of bingo gaming systems. The following description of the present invention will be made in reference to a particular bingo gaming system disclosed fully in U.S. Patent Application Publication No. 2004/0152499 A1 entitled “Method, System, and Program Product for Conducting Multiple Concurrent Bingo-Type Games,” the entire content of which is incorporated herein by this reference. However, it should be noted that the invention is not limited to any particular bingo gaming system. Rather, the invention may be used in connection with any bingo gaming system.

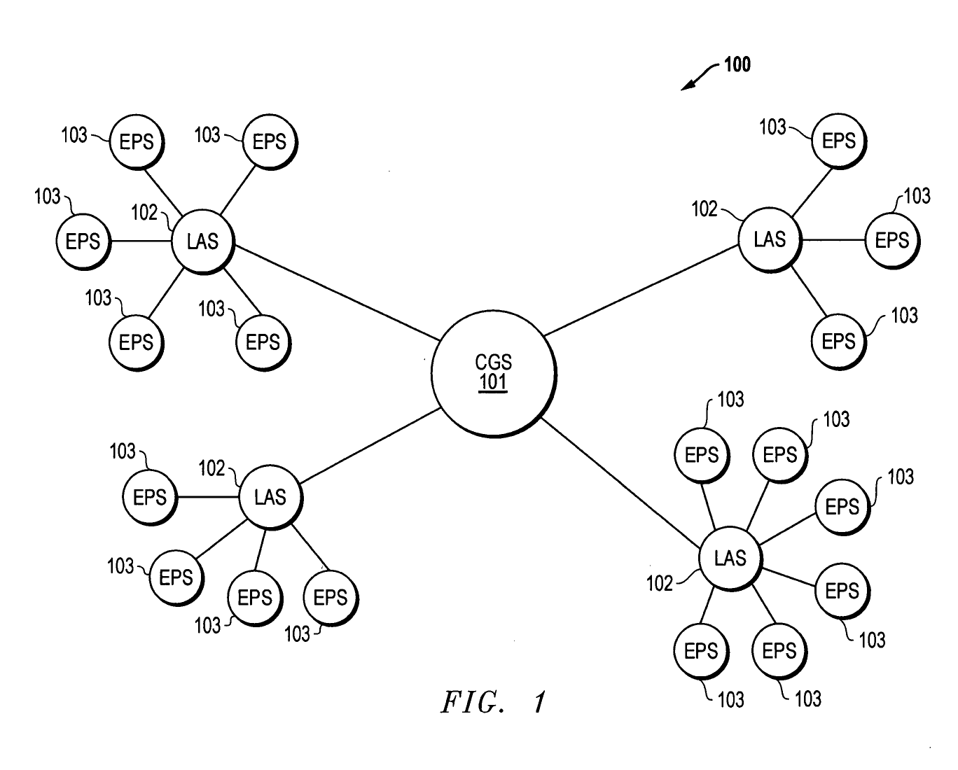

FIG. 1 shows a gaming system 100 including a central game server (CGS) 101 that cooperates with a number of other components to enable bingo players, preferably at many different remote gaming sites (also referred to herein as gaming locations), to participate in bingo games. Each gaming location includes a local area server (LAS) 102 and a number of electronic player stations (EPSs) 103. Electronic player stations such as EPSs 103 in FIG. 1 may also be referred to throughout this disclosure and the accompanying claims as “player stations.” In the normal operation of gaming system 100, CGS 101 functions as a game server to conduct bingo games so that a player at any EPS 103 in the system may participate in a given bingo game with players at any other EPSs 103 in the system. Thus, players at different gaming locations may be grouped together for a given bingo game administered through system 100. Grouping together players from different gaming facilities for the play of a bingo game allows different bingo games to be played rapidly and minimizes the time that players must wait to receive the result of their participation in the bingo game. However, gaming system 100 may be configured such that a LAS 102 may conduct bingo games between players at the LAS's local EPSs 103. In these instances, the respective LAS 102 functions as a game server.

The invention includes an arrangement for grouping players and/or game play requests for the play of a single bingo game to facilitate rapid play. This grouping includes limiting the number of players and/or game play requests included in a bingo game to reduce the time required to play the game. System 100 reduces the time between a game play request at one of the EPSs 103 and the return of results to the respective EPS sufficiently to allow a great deal of flexibility in how results in the bingo game are displayed to the player. In particular, the bingo game results may be displayed in some manner unrelated to bingo. For example, the bingo game results may be mapped to a display traditionally associated with a reel-type game (slot machine), to a display relating to a card game, or to a display showing a race such as a horse or dog race, for example. Preferred techniques for mapping bingo game results to displays associated with games or contests unrelated to bingo are described in U.S. Patent Application Publication No. 2002/0132661 A1 entitled “Method, Apparatus, and Program Product for Presenting Results in a Bingo-Type Game.” The entire content of this prior application is incorporated herein by this reference.

System 100 rapidly groups players and/or game play requests and starts one game after another so that multiple games may be in play at any given time. The number of players or game play requests grouped for the play of bingo games according to the present invention may be limited to reduce the time required for grouping. For example, each bingo game offered through gaming system 100 shown in FIG. 1 may be limited to between 2 to 15 players or game play requests.

Regardless of the rapid play facilitated by system 100 and regardless of the manner in which the bingo game results are displayed, the underlying game remains a standard bingo game played in the traditional sequence of play for bingo games. That is, each player obtains or is assigned a bingo card or bingo card representation, a random or pseudo random sequence of designations is generated, then all bingo cards in play in the game are daubed or checked for matches with the sequence of designations, and the first card in the game to match the sequence of designations to produce the game ending winning pattern wins the bingo game.

Additional prizes may be awarded for other patterns that may be produced in the course of the bingo game. The mapping of different prizes to various bingo patterns that may be produced in the course of a bingo game in system 100 may be accomplished as described in U.S. Pat. No. 6,569,017 B2, entitled “Method for Assigning Prizes in Bingo-Type Games” or U.S. Patent Application Publication No. 2004/0048647 A1, entitled “Prize Assignment Method and Program Product for Bingo-Type Games.” The entire content of each of these documents is incorporated herein by this reference.

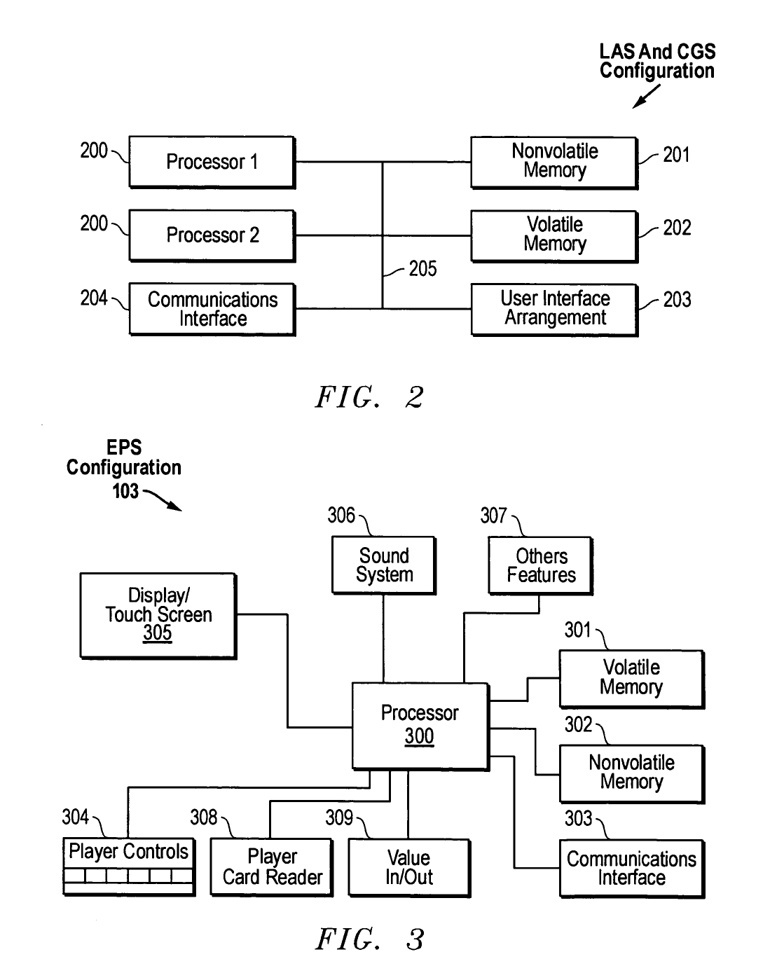

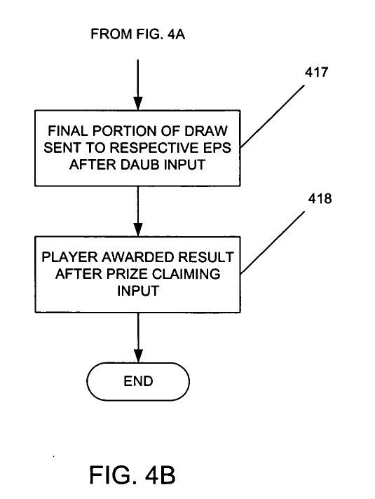

CGS 101 may comprise a computer system such as the basic system shown in FIG. 2. The basic system may include one or more processors 200, nonvolatile memory 201, volatile memory 202, a user interface arrangement 203, and a communications interface 204, all connected to a system bus 205. It will be appreciated that user interface arrangement 203 may include a number of different devices such as a keyboard, a display, and a pointing device such as a mouse or trackball for example, although not shown in FIG. 2. Alternatively to the integrated user interface arrangement 203 shown in FIG. 2, a user interface for CGS 101 may be provided through a separate computer (not shown) in communication with the CGS. Regardless of the particular configuration for CGS 101, in the normal operation of system 100 shown in FIG. 1, the CGS functions to group players for participation in bingo games offered through the system, produces or obtains sequences of designations for the play of the bingo games, checks for the results in the bingo games, and communicates the results to LASs 102. The specific sequence in which a game server such as CGS 101 performs these functions will be described below with reference to FIGS. 4A and 4B.

As used in this disclosure any sequence of designations that may be matched against bingo cards or card representations in the present gaming system will be referred to as a “ball draw” or simply a “draw” regardless of how the sequence is actually generated. Under this definition, it will be appreciated that a draw/ball draw may be produced by a random number generator, a pseudo random number generator, or any other suitable device or system, and not necessarily a physical ball draw device.

Each LAS 102 included in system 100 as shown in FIG. 1 may comprise a computer system having the same basic structure as shown in FIG. 2. That is, each LAS 102 may include one or more processors 200, nonvolatile memory 201, volatile memory 202, user interface arrangement 203, and communications interface 204 all connected to system bus 205. As with CGS 101, the user interface for the respective LAS 102 may be provided through a separate computer in communication with the LAS rather than the integrated user interface arrangement 203 shown in FIG. 2. Regardless of the specific configuration of the LAS, each LAS serves, in normal operation of the system shown in FIG. 1, to transfer or relay information from its respective EPSs 103 to CGS 101 and transfer or relay information from the CGS to the LAS's respective EPSs. As mentioned above, each LAS 102 according to the present invention may also have the ability to group players and actually play bingo games in certain situations, such as during times of high player activity at a given gaming location or when communications with CGS 101 are degraded or severed.

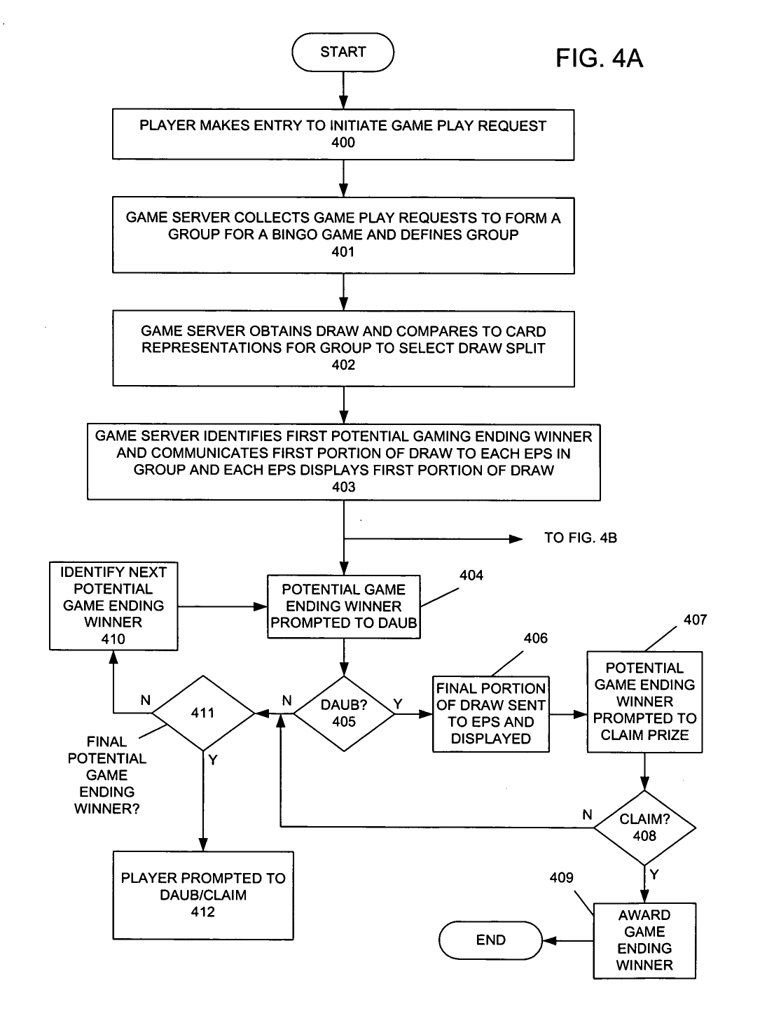

FIG. 3 shows an example of an EPS 103 that may be used in a gaming system embodying the principles of the present invention. The illustrated EPS 103 includes a processor 300, volatile memory 301, nonvolatile memory 302, and a communications interface 303. The volatile and nonvolatile memory stores computer program code that may be executed by processor 300 to cause the processor to perform or direct the various functions provided by EPS 103. Communications interface 303 allows communications between EPS 103 and its respective LAS 102 and/or CGS 101. EPS 103 also includes a special user interface arrangement to facilitate player participation in the bingo games offered through gaming system 100 shown in FIG. 1, and display results in an exciting and attractive format. This interface includes player controls 304, a display or touch screen display 305, a sound system 306, and perhaps other features 307 such as alarms or special displays or alerting devices. Each EPS 103 also preferably includes a convenient system for allowing the player to input player-specific information and for receiving wagers and dispensing winnings. For example, the EPS 103 shown in FIG. 3 includes a player card reader 308 that is adapted to read player-specific information from a player account card inserted into the reader. A player account card may, for example, include player information or simply a player identifier encoded on a magnetic medium (mag stripe) associated with the player account card, or encoded on bar code, or a memory device associated with the player account card. The illustrated EPS 103 also includes a device 309 for receiving value and issuing value in the course of play. This device may accept currency, vouchers, or tokens, for example, and also output currency, vouchers, or tokens. Of course, a separate device may be used to receive and issue value for games played according to the present invention. Alternatively or in addition to value in/out device 309, EPSs 103 may read player account information from the player account card or player information otherwise input at the EPS, and account for wagers and winnings in the manner set out in U.S. Patent Application Publication No. 2002/0132666 A1, entitled “Distributed Account Based Gaming System,” the entire content of which is incorporated herein by this reference.

It will be appreciated that the particular configuration of devices shown in FIG. 1 is shown only for purposes of example. A bingo gaming system according to the present invention may omit some or all of the separate LAS's 102 at the various gaming locations so that the EPSs 103 communicate directly with CGS 101. Also, various regions or different gaming locations may be divided up into separate systems each having a respective CGS such as CGS 101. In these situations the system could be configured such that a single EPS 103 may be serviced by any of the CGSs. Furthermore, a gaming system embodying the principles of the invention may include multiple CGSs rather that a single CGS 101 as shown in FIG. 1.

Details regarding the particular functions performed by CGS 101, LASs 102, and EPSs 103 according to one preferred system in which the present invention may be employed are described in U.S. Patent Application Publication No. 2004/0152499 A1, which has previously been incorporated by reference. These details regarding the particular functions of CGS 101, LASs 102, and EPSs 103 will not be repeated here so as not to obscure the present invention in unnecessary detail. For purposes of the present invention and disclosure, it should be noted that one or more components of the system is responsible for grouping game play requests from a number of players and conducting a bingo game between the group of players. Other components of the system allow players to enter game play requests and take other actions as described below and view the results of the game play requests.

In the following description of FIGS. 4A and 4B it will be appreciated that the references to the physical components are references to the diagrams in FIGS. 1, 2, and 3 that show those components. The components, such as EPSs 103, LASs 102, and CGS 101 discussed with reference to the flowcharts of FIGS. 4A and 4B are generally not shown in the flowcharts themselves but are shown particularly in FIG. 1.

Bingo games in the preferred system 100 are each played with predefined electronic bingo card representations (“card representations”) each representing a number of bingo designations such as Arabic numerals randomly arranged in a desired manner, commonly in a grid. The bingo designations in the card representations are selected from a pool of available designations. In the play of a bingo game according to the invention the individual card representations in a game are matched by designations in a ball draw in order to identify a game ending winning player and the bingo game results for other players. The game ending winning player owns or is associated with a respective card representation that matches the ball draw in a predefined game ending winning pattern. The results identified for other players may be associated with some prize or may be a losing result not associated with any prize.

FIGS. 4A and 4B show generally the sequence of play according to the present invention. Referring first to FIG. 4A, a player first makes an entry through an EPS 103 to initiate a game play request as indicated at process block 400. This entry preferably includes activating a suitable player control such as a button or touch screen icon at the respective EPS 103. As indicated at process block 401, the game server component of the system collects game play requests from various players to form a group of game play requests and associated card representations with which to conduct a bingo game. A preferred form of the system requires a minimum of two players for a group and a maximum of fifteen players. If the requisite number of players is not collected within a requisite time, the system refunds the player's wager associated with their game play request.

Once a group is defined for a bingo game, the component, or components, serving as the game server obtains a ball draw and compares the ball draw to the card representations in the defined group in order to split the ball draw into a first portion and a final portion. This initial comparison step is shown that process block 402. The split is preferably made at about one-half of the designations required for the first player in the group to achieve the game ending winning pattern, that is, for the card representation entered by the player to achieve the game ending winning pattern. As indicated at process block 403, the game server also identifies the first game ending winner and communicates the first portion of the draw to all EPSs 103 for the group that was collected for the game. The respective EPSs 103 also display the first portion of the draw. It will be appreciated that although the step of identifying the first potential game ending winner and communicating the first portion of the ball draw to the EPSs 103 is shown in a single process block, these processes may be separated within the scope of the present invention.

The first potential game ending winner, that is, the player owning the card representation that has first achieved the game ending winning pattern, must at this point make a player input at their respective EPS 103. As shown at process block 404, the potential game ending winner receives a daub prompt to make a daub input at their EPS 103, preferably by pressing a “DAUB” button or touch screen icon. If the player makes the daub input, the process branches from decision block 405 and the system sends the final portion of the ball draw to the potential game ending winner's EPS 103 and the EPS displays the final portion of the ball draw as indicated at process block 406. The potential game ending winner then receives a prize claiming prompt to make another input at the EPS 103 to claim the game ending win as indicated at process block 407. The required input may be actuating a “CLAIM” button, touch screen icon, or some other player control. If the player takes the required prize claiming input, the process branches from decision block 408 and the potential game ending winner is awarded the prize associated with the game ending winning pattern as indicated at block 409.

If the potential game ending winner fails to make the daubing input as indicated by the negative result at decision block 405 or fails to make the required prize claiming input as indicated by the negative result at decision block 408, the player is said to have “slept the bingo” and the process proceeds to identify a next potential game ending winner as indicated at process block 410. At this point the process loops back to process block 404 and the next potential game ending winner is given the opportunity to make the required player inputs, that is the daub input and the prize claiming input. It should be noted that in the event the current potential game ending winner given the opportunity to daub and claim the game ending win is the final potential game ending winner for the particular group, the process branches from decision block 411 and the player is given an unlimited amount of time to make the required daub and prize claiming inputs as indicated at process block 412. The final potential game ending winner for a particular group may be defined as the first potential game ending winner or any subsequent potential game ending winner.

FIG. 4B shows the process flow for players in the group other than the first potential game ending winner. In a preferred form of the invention, players other than the identified potential game ending winner are neither prompted to make a daubing input nor make a prize claiming input at their respective EPS 103. Rather, action at the respective EPS 103 is simply suspended until the player makes the required daubing input at the EPS. Once the player makes the required daub input, the final portion of the ball draw is sent to the respective EPS 103 and displayed at the EPS as indicated at process block 417 in FIG. 4B. After the final portion of the ball draw is displayed to the respective player at their EPS 103, the player must make a required prize claiming input. Again, the player is preferably not prompted to make the input, and the process is simply suspended at the respective EPS 103 until the input is made. Once the player makes the required prize claiming input at their EPS 103, the process continues on to process block 420 and the player is awarded their respective result. This result may be some level of winning result, or may be a losing result that is not associated with any prize.

It will be appreciated that there are numerous variations in the sequence of play as described in FIGS. 4A and 4B. In particular, although process block 406 and process block 417 indicate that the final portion of the ball draw is sent to the respective EPS at that point, it will be appreciated that the entire ball draw may have been sent to the EPS previously and the step at process block 406 and 417 in that case would comprise simply displaying the final portion of the ball draw at the respective EPS. Also, rather than simply suspending action at the respective EPSs 103 if a player other than the potential game ending winner does not make the daub or prize claiming inputs, a system according to the invention may prompt the player to make the required player inputs.

It will be noted that the preferred daub and claiming inputs at each EPS 103 affects the display at the respective EPS in preferred forms of the invention. Once the daub input is made, any designations matched on the player's respective card are highlighted. The player is required to make the prize claiming input to complete game play, highlight any winning bingo patterns, and receive any prizes won in the bingo game. Any winning bingo patterns are highlighted with red circles around the winning numbers. In a preferred form of the invention, each EPS 103 displays a representation of the player's card in play for the particular game. The respective EPS display also shows a game number or identifier associated with the particular game, and the designations included in the ball draw.

In preferred forms of the invention, although the game ending winning result or prize must be awarded for any game, other winning results are awarded only if they are attained within the first pre-specified number of designations in the ball draw, for example 30 designations. In a preferred form of the invention, when the player takes the initial action to make the game play request for their respective bingo card representation, the card is displayed at the EPS 103 with gray designations on a black background. When the designations on the card representation form a winning pattern in the course of the game, the designations change from gray on black to white numbers within a red circle. Designations released within the first set number of designations in the draw (30 for example) that do not form any winning pattern are displayed as black numbers within gray circles. Numbers that are revealed after the first set number of designations from the draw (for example 30) are displayed as white numbers on a black background.

The above described preferred embodiments are intended to illustrate the principles of the invention, but not to limit the scope of the invention. Various other embodiments and modifications to these preferred embodiments may be made by those skilled in the art without departing from the scope of the present invention. For example, although a particular hardware arrangement is shown for purposes of describing the invention, it will be appreciated that numerous hardware arrangements are possible for implementing the present invention. Also, although the operational software-controlled process steps are described as occurring at certain processing elements in the system, the processing steps may be distributed in any suitable fashion over various data processing elements.

1. A method including:
(a) splitting a ball draw for a bingo game into a first portion and a final portion to ensure that a first potential game ending winning player is not identified after considering only the first portion of the ball draw;
(b) presenting the first portion of the ball draw to the first potential game ending winning player;
(c) presenting the final portion of the ball draw to the first potential game ending winning player in the event the first potential game ending winning player enters a daub input according to a daub input rule; and
(d) awarding a prize to the first potential game ending winning player in the event the first potential game ending winning player enters a prize claiming input according to a prize claiming input rule.

2. The method of claim 1 further including:
(a) identifying a next potential game ending winning player in the event the first potential game ending winning player fails to enter the daub input according to the daub input rule;
(b) presenting the final portion of the ball draw to the next potential game ending winning player in the event the next potential game ending winning player enters a respective daub input according to the daub input rule; and
(c) awarding a respective prize to the next potential game ending winning player in the event the next potential game ending winning player enters a respective prize claiming input according to the prize claiming input rule.

3. The method of claim 1 further including:
(a) identifying a next potential game ending winning player in the event the first potential game ending winning player fails to enter the prize claiming input according to the prize claiming input rule;
(b) presenting the final portion of the ball draw to the next potential game ending winning player in the event the next potential game ending winning player enters the respective daub input according to the daub input rule; and
(c) awarding a respective prize to the next potential game ending winning player in the event the next potential game ending winning player enters a respective prize claiming input according to the prize claiming input rule.

4. The method of claim 1 further including presenting the first portion of the ball draw to each player in the bingo game.

5. The method of claim 1 wherein the daub input rule includes a daubing time period measured from the time at which a respective player is presented with the first portion of the ball draw, and in which daubing time period the respective player must make a respective daub input.

6. The method of claim 1 wherein the prize claiming rule includes a prize claiming time period measured from the time at which a respective player is presented the final portion of the ball draw, and in which prize claiming time period the respective player must make a respective prize claiming input.

7. The method of claim 1 further including providing the first potential game ending winning player with a daub prompt to enter the daub input and a prize claiming prompt to enter the prize claiming input.

8. The method of claim 2 further including:
(a) identifying an additional potential game ending winning player in the event the next potential game ending winning player fails to enter the respective daub input according to the daub input rule;
(b) presenting the final portion of the ball draw to the additional potential game ending winning player in the event the additional potential game ending winning player enters a respective daub input according to the daub input rule; and
(c) awarding a respective prize to the additional potential game ending winning player in the event the additional potential game ending winning player enters a respective prize claiming input according to the prize claiming input rule.

9. A method including:
(a) splitting a ball draw for a bingo game into a first portion and a final portion; and
(b) identifying a series of one or more potential game ending winning players and presenting the first portion of the ball draw, the final portion of the ball draw, and a prize to the first of the one or more potential game ending winning players to enter two or more separate player inputs according to player input rules of the bingo game.

10. The method of claim 9 wherein a first one of the potential game ending winning players can be identified only after considering the final portion of the ball draw.

11. The method of claim 9 wherein the player input rules include a daub input rule that requires a daub input by a respective player within a daubing time period after the respective player is presented with the first portion of the ball draw.

12. The method of claim 11 wherein the player input rules include a prize claiming input rule that requires a prize claiming input by a respective player within a prize claiming time period after the respective player is presented with the final portion of the ball draw.

13. The method of claim 9 further including the step of presenting the first portion of the ball draw to each player in the bingo game.

14. An apparatus including:
(a) a number of player stations through which a respective player may participate in a bingo game, each player station including a display, and one or more player input devices; and
(b) a game server for splitting a ball draw for the bingo game into a first portion and a final portion, for identifying a series of one or more potential game ending winning players and for directing a respective player station to present the first portion of the ball draw, the final portion of the ball draw, and a prize indicator, the respective player station comprising the player station for the first of the one or more potential game ending winning players to enter two or more player inputs according to player input rules for the bingo game.

15. The apparatus of claim 14 wherein the game server splits the ball draw into the first portion and the second portion to ensure that no potential game ending winning player can be identified when considering only the first portion of the ball draw.

16. The apparatus of claim 14 wherein the one or more player input devices enable a player at the player station to enter a daub input.

17. The apparatus of claim 14 wherein the one or more player input devices enable a player at the player station to enter a prize claiming input.

18. The apparatus of claim 14 wherein the game server identifies each successive potential game ending winning player in the event a preceding potential game ending winning player failed to enter both a daub input and a prize claiming input according to the player input rules for the bingo game.

19. The apparatus of claim 14 wherein each player station is operatively connected to the game server through a respective local area server.

20. The apparatus of claim 19 including two or more local area servers, each local area server associated with a different gaming location and operatively connecting a separate set of the player stations to the game server.
